(19) United States
(12) Patent Application Publication
(10) Pub. No.: US 2025/0108774 A1
(43) Pub. Date: Apr. 3, 2025

(54) SAFETY BELT STRUCTURE

(71) Applicant: TAIWAN RACING PRODUCTS CO., LTD., Changhua County (TW)

(72) Inventor: Wen-Yuan Wu, Changhua County (TW)

(73) Assignee: TAIWAN RACING PRODUCTS CO., LTD., Changhua County (TW)

(21) Appl. No.: 18/477,404

(22) Filed: Sep. 28, 2023

(51) Int. Cl. B60R 22/02; A44B 11/25

(52) U.S. Cl. CPC B60R 22/023; A44B 11/2549; B60R 2022/027

(57) ABSTRACT

A safety belt structure of racing cars that can be quickly put on and taken off is disclosed. The safety belt structure includes a buckle socket, a buckle clip, and two elastic buckle locks. One end of the buckle socket and the buckle clip are mutually buckled and have a socket part and a clip part. The other ends of the buckle socket and the buckle clip both have a strap-through part and are respectively pivoted with a transverse safety belt. The buckle socket and the buckle clip both have a quick-release buckle clip protruding on one side. One end of the elastic buckle lock has a slot formed to allow the quick-release buckle clip to be inserted into, and the elastic buckle lock can be quickly released by pressing. The other ends of the two elastic buckle locks are formed with a long slot for installing a shoulder safety belt. Accordingly, the two elastic buckle locks can be used to achieve the effect of quickly putting on and taking off the shoulder safety belts.

### BACKGROUND OF THE INVENTION

### Field of the Invention

This invention relates to a safety belt structure, in particular to a safety belt structure of racing cars that can be quickly put on and taken off.

### Description of the Related Art

The safety belt, also known as the seat belt, is used to protect people when riding or driving vehicles, reduce collision or impact by fixing the passengers and the driver to the seat, and prevent the occurrence of being thrown away to reduce the occurrence of secondary injuries. According to different types of needs, there are different types of safety belts to protect users. For example, the transverse beam type that is tied around the waist. For another example, three-point, four-point, and five-point safety belts are more common. As shown in FIG. 11 and FIG. 12, the four-point safety belt includes a buckle socket 40 and a buckle clip 50 that are fastened together. The buckle socket 40 and the buckle clip 50 are both connected to a horizontal safety belts 41 and 51 and the shoulder safety belts 42 and 52. The buckle socket 40 and the buckle clip 50 simultaneously reach the transverse safety belts 41 and 51 and the shoulder safety belts 42 and 52 to further tighten the body to achieve protection and buffering purposes.

The above-mentioned conventional structure has some shortcomings. The conventional buckle socket 40 and the buckle clip 50 are both connected to the transverse safety belts 41 and 51 and the shoulder safety belts 42 and 52. Four seat belts are tightened together through the buckle socket 40 and the buckle clip 50. When the seat belts want to be loosened and released, the buckle socket 40 is operated. The four safety belts can be loosened at the same time. However, in fact, when the shoulder safety belts 42 and 52 are tightened, the buckle 40 and the buckle clip 50 will be pulled upward at the same time, causing Interference of the buckle socket 40 and the buckle clip 50 and affecting the smoothness of loosening and releasing the seat belt. When the buckle socket 40 is detached from the buckle clip 50, the shoulder safety belts 42 and 52 still surround the arms and shoulders, which requires the shoulder safety belt 42 to be further removed from the arms to finish the operation. Hence, the shoulder safety belt 42 does not have the effect of quickly putting on and taking off the safety belt and so that greatly increases the release time of the safety belt. In case of emergency situations such as collisions, rollovers and other major car accidents, if the safety belt cannot be released immediately, the driver will be difficult to escape, which will delay the golden rescue time and cause irreparable regrets.

### SUMMARY OF THE INVENTION

The technical problem to be solved by this invention is to provide a safety belt structure of racing cars that can be quickly put on and taken off in view of the above-mentioned deficiencies in the existing technology. The safety belt structure includes a buckle socket, a buckle clip, and two elastic buckle locks. One end of the buckle socket and the buckle clip are mutually buckled and have a socket part and a clip part. The other ends of the buckle socket and the buckle clip both have a strap-through part and are respectively pivoted with a transverse safety belt. The buckle socket and the buckle clip both have a quick-release buckle clip protruding on one side. One end of the elastic buckle lock has a slot formed to allow the quick-release buckle clip to be inserted into, and the elastic buckle lock can be quickly released by pressing. The other ends of the two elastic buckle locks are formed with a long slot for installing a shoulder safety belt. Accordingly, the two elastic buckle locks can be used to achieve the effect of quickly putting on and taking off the shoulder safety belts.

Preferably, the elastic buckle lock has a bottom case, an elastic plate, a front cover, and a pressure plate. The two sides of the bottom case are symmetrically bent inwards and provided with two limiting parts, one end of the bottom case includes a blocking part, and two limiting parts and the blocking part are not in contact to form the slot. The elastic plate has a protruding part and a hollow part located above the protruding part, and a spring piece is provided at the bottom of the elastic plate and is assembled in the bottom case.

The bottom end of the elastic plate is against the blocking part, and the other end of the spring piece is away from the elastic plate to form an inner support part. The inner support part is against the inner wall of the bottom case and faces the hollow part, so that the other end of the elastic plate leans toward the two limiting parts. A through hole is provided in the center of the front cover, and the pressure plate is assembled on the inside of the front cover. The front cover is assembled on the front side of the bottom case. The pressure plate faces the elastic plate, and the pressure plate is provided with two inner push plates to support the elastic plate. The pressure plate can be pressed through the through hole, so that the elastic plate has an action state of pressing to unlock and rebounding the lock.

Preferably, the quick-release buckle clip is provided with a clip hole, and the clip hole is snap-fitted with the protruding part, and further inserts and fixes the quick-release buckle clip on the elastic buckle locks.

Compared to the prior art, the present invention has the following advantages. The elastic buckle lock is installed with a shoulder safety belt through the long slot of the lug, and then the elastic buckle lock is connected to the quick-release buckle clip of the buckle socket and the buckle clip through the slot. The socket part of the buckle socket and the clip part of the buckle clip are buckled and fixed to complete the buckle fastening state of at least the four-point safety belt.

Based on this, when the driver wants to release the seat belt, after the buckle socket is released from the buckle clip, the elastic buckle locks can be quickly released from the buckled state by pressing the elastic buckle locks. The reaction force generated by the fastened state causes the elastic buckle locks to jump upward and release the buckle socket and the quick-release buckle clip of the buckle clip, so as to achieve the purpose of quickly releasing the safety belt. The invention can help to gain time to escape after an accident, avoid the regret of being unable to escape immediately due to an emergency, and greatly improve the safety of seat belt use.

### BRIEF DESCRIPTION OF THE DRAWINGS

The following drawings are merely examples for illustrative purposes according to various disclosed embodiments and are not intended to limit the scope of the present disclosure.

FIG. 1 illustrates a three-dimensional view of the buckle socket, buckle clip, and elastic buckle locks in a connected state.

FIG. 2 illustrates a three-dimensional view of the buckle socket, buckle clip, and elastic buckle locks in a released state.

FIG. 3 illustrates an exploded view of the elastic buckle lock.

FIG. 4 illustrates a schematic diagram of the quick-release buckle clip and the elastic buckle lock.

FIG. 5 illustrates a cross-sectional view of the quick-release buckle clip and the elastic buckle lock.

FIG. 6 illustrates a cross-sectional view of the quick-release buckle clip and the elastic buckle lock.

FIG. 7 illustrates a schematic diagram of the quick-release buckle clip and the elastic buckle lock.

FIG. 8 illustrates a cross-sectional view of the quick-release buckle clip and the elastic buckle lock after pressing to release.

FIG. 9 illustrates a schematic diagram of the buckle socket, buckle clip, and elastic buckle locks in a connected state.

FIG. 10 illustrates a schematic diagram of the buckle socket, buckle clip, and elastic buckle locks in a released state.

FIG. 11 illustrates a schematic diagram of the conventional safety belt in a connected state.

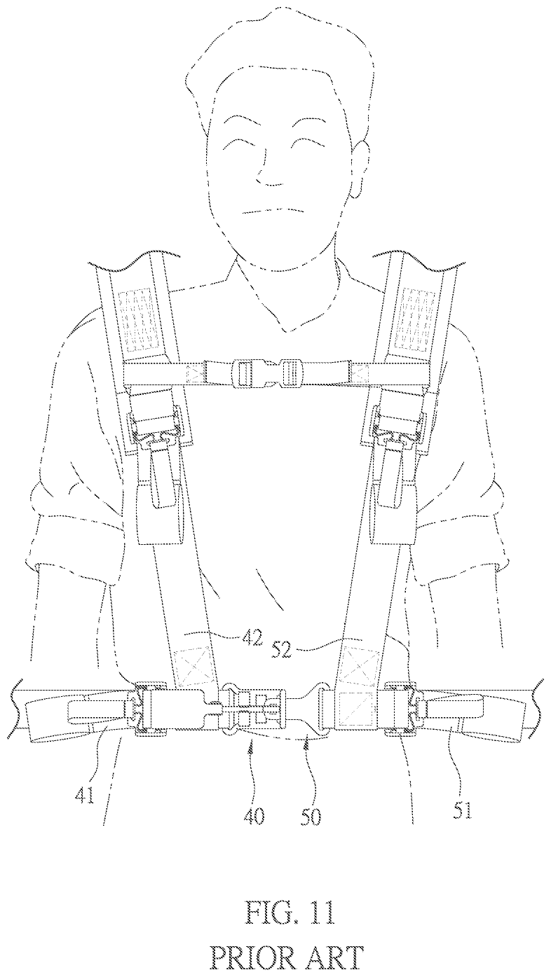

FIG. 12 illustrates a schematic diagram of the conventional safety belt in a released state.

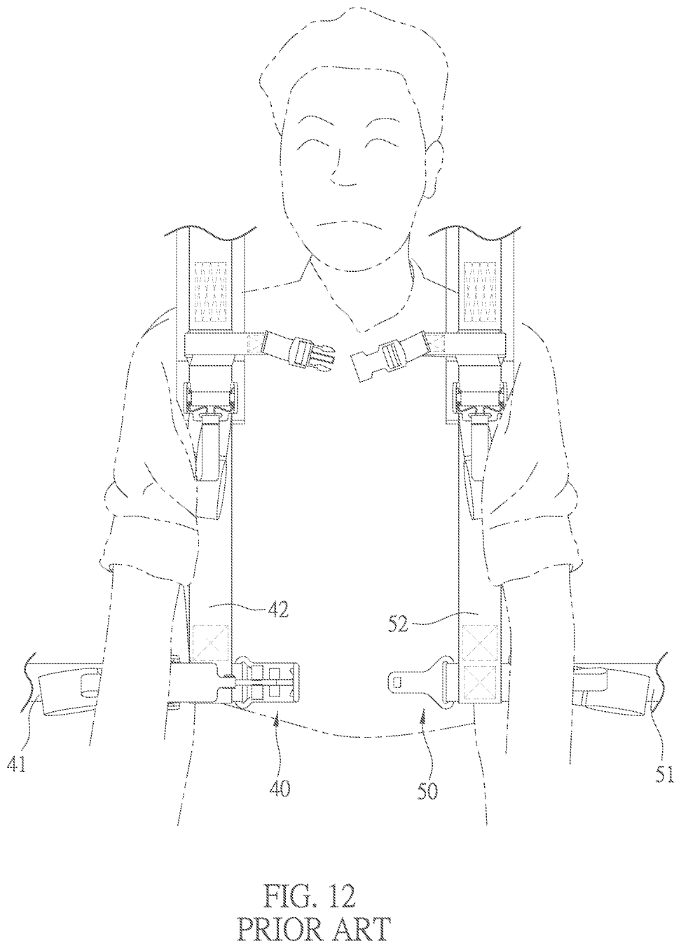

### DETAILED DESCRIPTION OF THE INVENTION

Reference will now be made in detail to exemplary embodiments of the invention, which are illustrated in the accompanying drawings. Hereinafter, embodiments consistent with the disclosure will be described with reference to drawings. Wherever possible, the same reference numbers will be used throughout the drawings to refer to the same or like parts. It is apparent that the described embodiments are some but not all of the embodiments of the present invention. Based on the disclosed embodiment, persons of ordinary skill in the art may derive other embodiments consistent with the present disclosure, all of which are within the scope of the present invention.

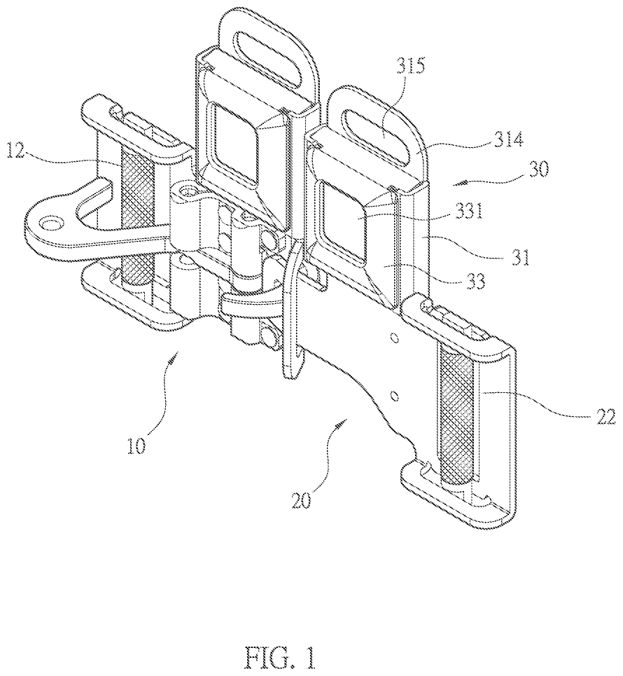

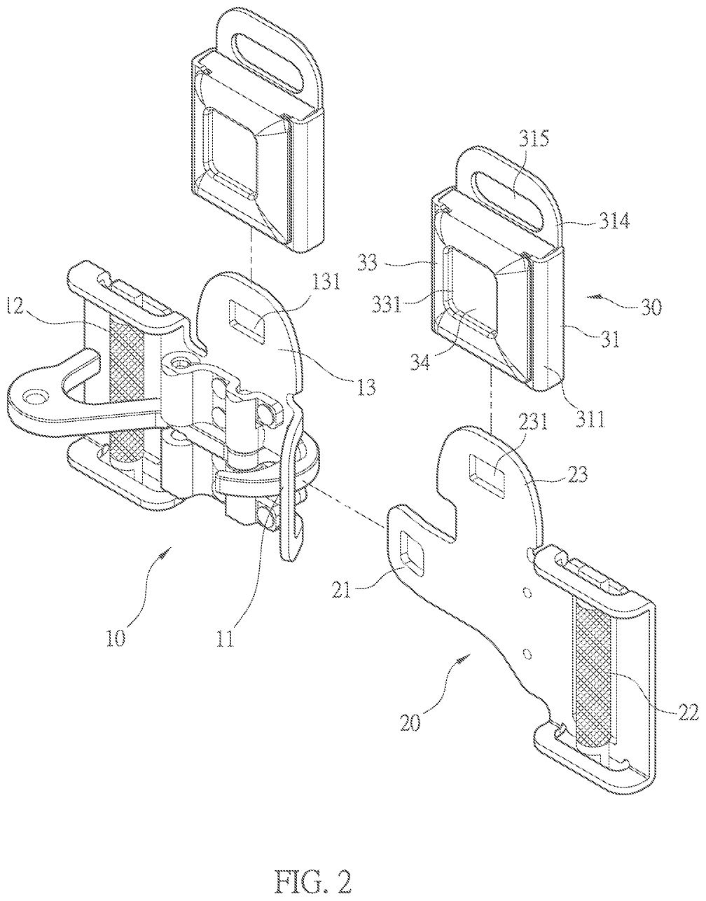

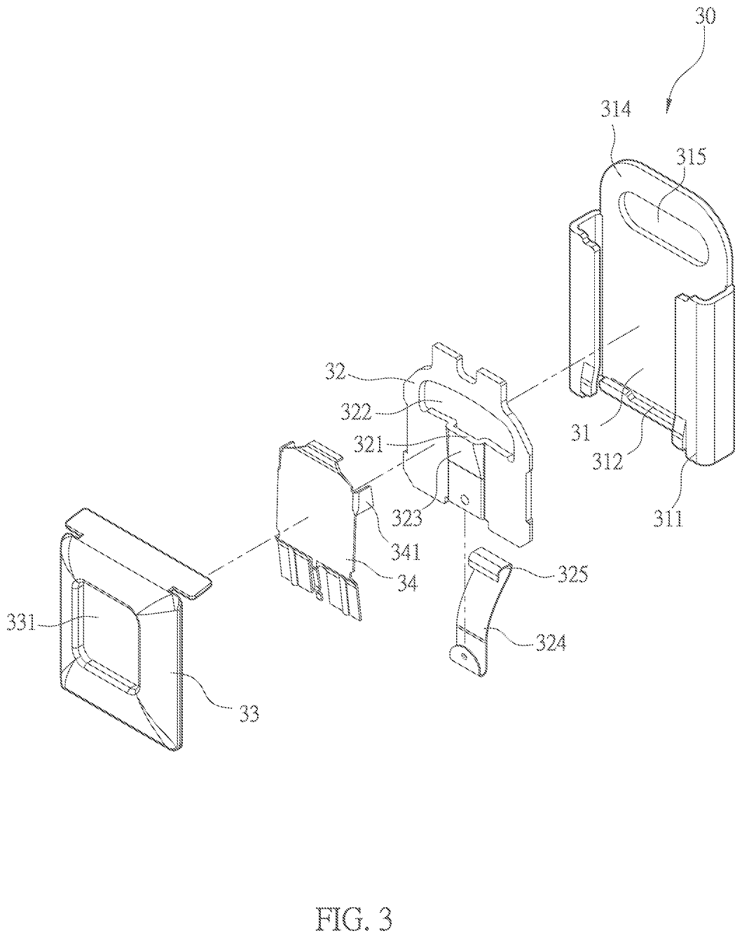

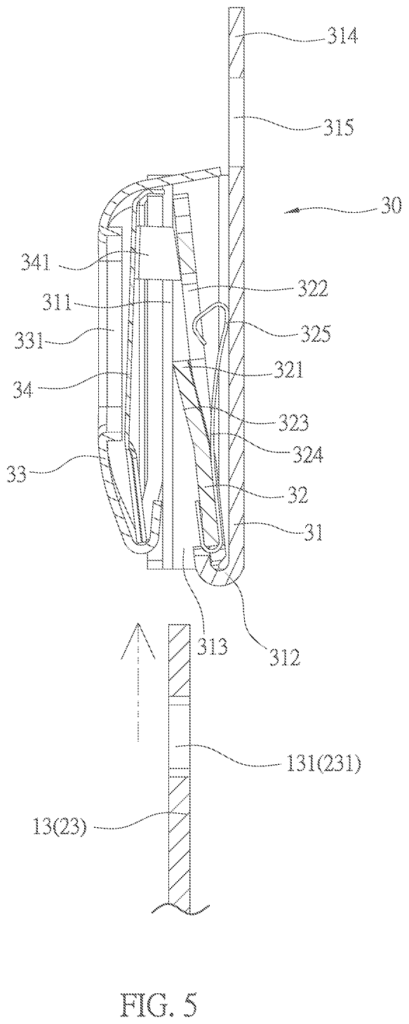

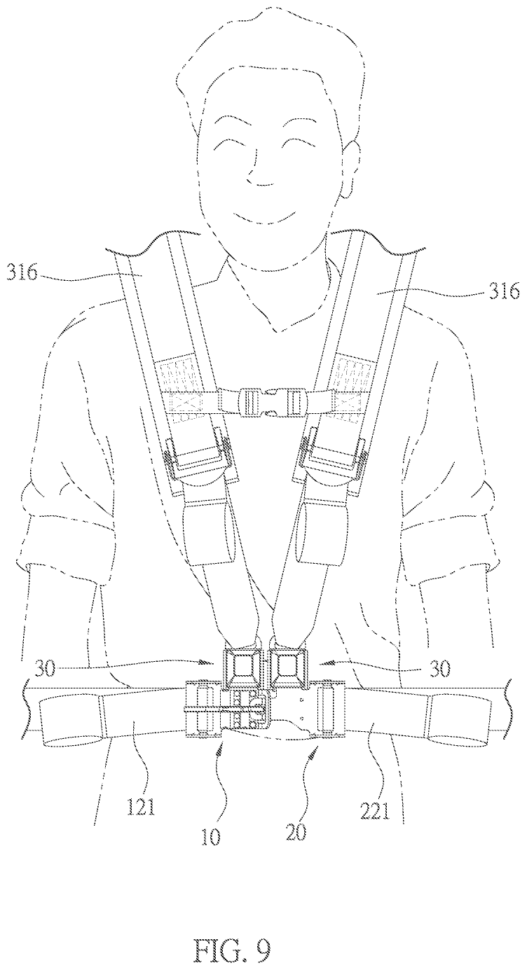

Referring to FIGS. 1-5, a safety belt structure of racing cars is disclosed. The safety belt structure includes a buckle socket 10, a buckle clip 20, and two elastic buckle locks 30. One end of the buckle socket 10 and the buckle clip 20 are mutually buckled and have a socket part 11 and a clip part 21. The other ends of the buckle socket 10 and the buckle clip 20 both have strap-through parts 12 and 22 and are respectively pivoted with transverse safety belts 121 and 221 (as shown in FIG. 9). The buckle socket 10 and the buckle clip 20 both have quick-release buckle clips 13 and 23 protruding on one side. The quick-release buckle clips 13 and 23 are provided with clip holes 131 and 231.

The elastic buckle lock 30 has a bottom case 31, an elastic plate 32, a front cover 33, and a pressure plate 34. The two sides of the bottom case 31 are symmetrically bent inwards and provided with two limiting parts 311. One end of the bottom case 31 includes a blocking part 312, and two limiting parts 311 and the blocking part 312 are not in contact to form the slot 313. The other end of the bottom case 31 is provided with a lug 314, and the lug 314 is provided with a long slot 315 for installing a shoulder safety belt 316 (as shown in FIG. 9). The elastic plate 32 has a protruding part 321 and a hollow part 322 located above the protruding part 321. The protruding part 321 has a guiding slope 323 from bottom to top. A spring piece 324 is provided at the bottom of the elastic plate 32 and is assembled in the bottom case 31. The bottom end of the elastic plate 32 is against the blocking part 312, and the other end of the spring piece 324 is away from the elastic plate 32 to form an inner support part 325. The inner support part 325 is against the inner wall of the bottom case 31 and faces the hollow part 322, so that the other end of the elastic plate 32 leans toward the two limiting parts 311. A through hole 331 is provided in the center of the front cover 33, and the pressure plate 34 is assembled on the inside of the front cover 33. The front cover 33 is assembled on the front side of the bottom case 31. The pressure plate 34 faces the elastic plate 32, and the pressure plate 34 is provided with two inner push plates 341 to support the elastic plate 32. The pressure plate 34 can be pressed through the through hole 331, so that the elastic plate 32 has an action state of pressing to unlock and rebounding the lock.

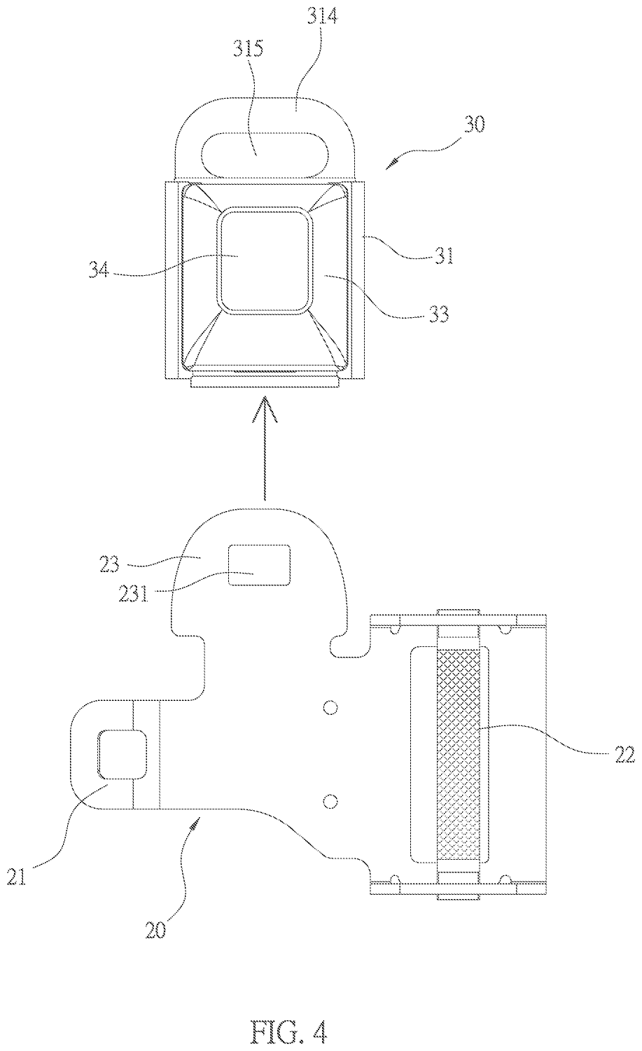

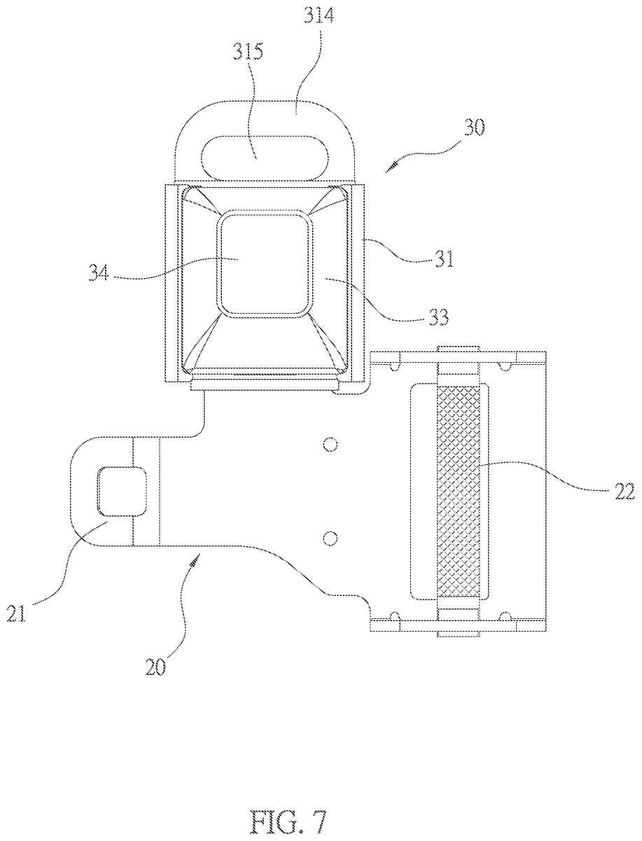

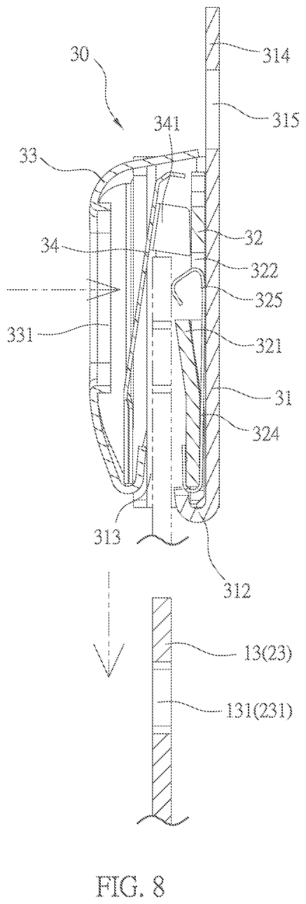

FIGS. 4-8 illustrate the various using states of the elastic buckle lock 30. When the elastic buckle lock 30 is not plugged into the quick-release buckle clips 13 and 23, the spring piece 324 of the elastic plate 32 is pressed against the inner wall of the bottom case 31 with the inner support part 325, and the top end of the elastic plate 32 is tilted toward the limiting part 311 of the bottom case 31, so that the protruding part 321 of the elastic plate 32 relatively locate above the slot 313. The pressure plate 34 on the inside of the front cover 33 pushes the inner push plate 341 past the limiting part 311 and against the surface of the elastic plate 32. Accordingly, when the quick-release buckle clips 13 and 23 of the buckle socket 10 or buckle clip 20 are inserted into the elastic buckle lock 30 through the slot 313, the quick-release buckle clips 13 and 23 will gradually squeeze the elastic plate 32 along the guide slope 323. At the same time, the spring piece 324 is compressed until the clip holes 131 and 231 are opposite to the protruding part 321. At this time, the elastic plate 32 rebounds through the inner support part 325 of the spring piece 324 to lock the protruding part 321 onto the clip holes 131 and 231, and the quick-release buckle clips 13 and 23 are further inserted and fixed on the elastic buckle lock 30 to achieve the lock between the quick-release buckle clips 13 and 23 and the elastic buckle lock 30. On the contrary, when the user wants to release the quick-release buckle clips 13 and 23 from the locked state of the elastic buckle lock 30, the user can press the pressure plate 34 through the through hole 331 of the front cover 33, so that the pressure plate 34 moves inward and use the two inner push plates 341 to push the elastic plate 32 inward, so that the protruding part 321 is separated from the clip holes 131 and 231 of the quick-release buckle clips 13 and 23. At this time, the quick-release buckle clips 13 and 23 can be pulled out or naturally hang down using their own weight, so as to achieve the effect of quick release of the quick-release buckle clips 13 and 23.

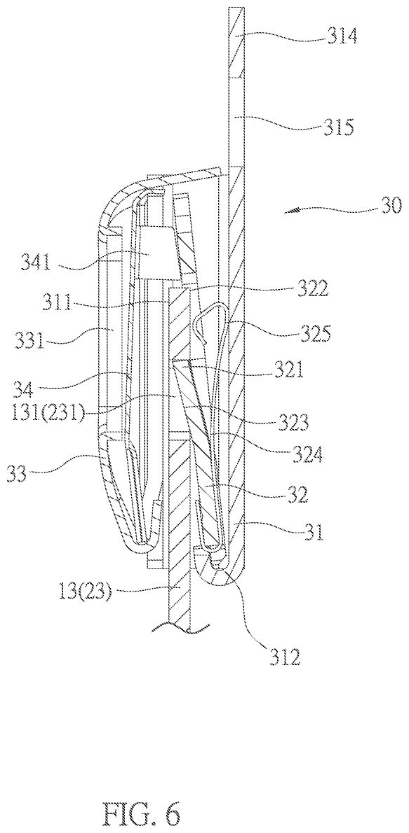

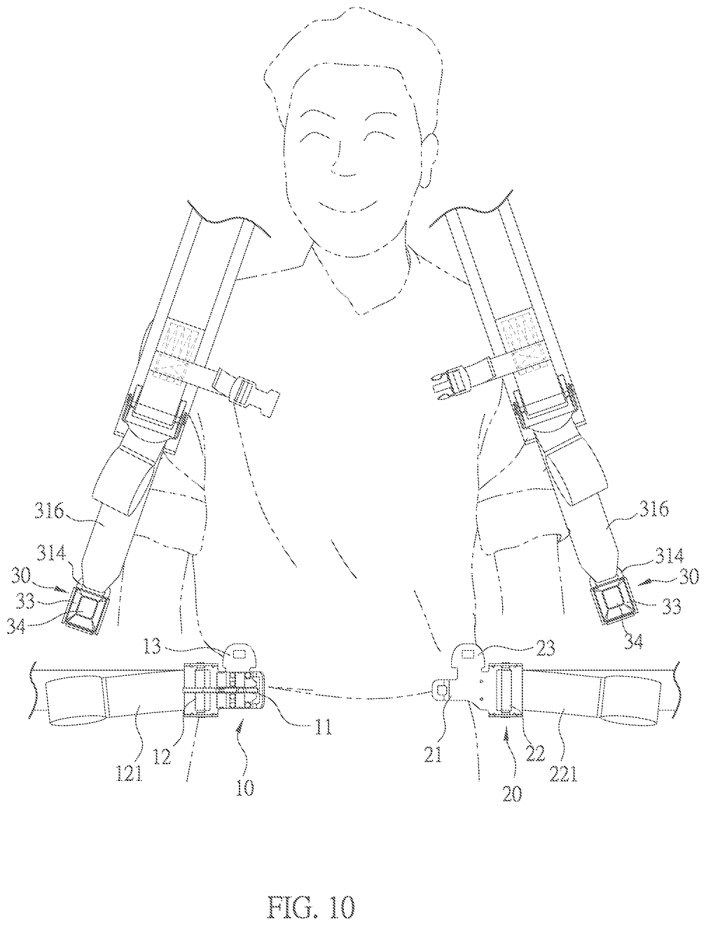

Following the above, please continue to refer FIGS. 9-10 together with FIGS. 6-8. The elastic buckle lock 30 is installed with a shoulder safety belt 316 through the long slot 315 of the lug 314. The elastic buckle lock 30 is inserted and combined and the quick-release buckle clips 13 and 23 of the buckle socket 10 the buckle clip 20 through the slot 313. The socket part of the buckle socket 10 and the clip part 21 of the buckle clip 20 are buckled and fixed to complete the buckle fastening state of at least the four-point safety belt.

Based on this, when the user wants to release the seat belt, after the buckle socket 10 is released from the buckle clip 20, the elastic buckle locks 30 can be quickly released from the buckled state by pressing the elastic buckle locks 30. The reaction force generated by the fastened state causes the elastic buckle locks 30 to jump upward and release the quick-release buckle clips 13 and 23 of the buckle socket 10 and the buckle clip 20, so as to achieve the purpose of quickly releasing the safety belt. The invention can help to gain time to escape after an accident, avoid the regret of being unable to escape immediately due to an emergency, and greatly improve the safety of seat belt use.

Other embodiments of the disclosure will be apparent to those skilled in the art from consideration of the specification and practice of the invention disclosed herein. It is intended that the specification and examples be considered as exemplary only, with a true scope and spirit of the invention being indicated by the claims.

1. A safety belt structure comprising a buckle socket, a buckle clip, and two elastic buckle locks, wherein
one end of the buckle socket and one end of the buckle clip are buckled, the other end of the buckle socket and the other end of the buckle clip each comprises a strap-through part and are respectively pivoted with a transverse safety belt,
the buckle socket and the buckle clip both comprise a quick-release buckle clip protruding on one side, one end of each elastic buckle lock comprises a slot to allow the quick-release buckle clip to be inserted into, and the elastic buckle lock is quickly released by pressing,
the other end of each elastic buckle lock is formed with a long slot for installing a shoulder safety belt.

2. The safety belt structure of claim 1, wherein each elastic buckle lock comprises a bottom case, an elastic plate, a front cover, and a pressure plate, wherein
two sides of the bottom case are symmetrically bent inwards and provided with two limiting parts, one end of the bottom case comprises a blocking part, and two limiting parts and the blocking part form a slot, and two limiting parts and the blocking part are formed on three sides of the bottom case,
the elastic plate comprises a protruding part and a hollow part located above the protruding part, and a spring piece is provided at a bottom of the elastic plate and is assembled in the bottom case,
a bottom end of the elastic plate is against the blocking part, and an end of the spring piece is away from the elastic plate to form an inner support part, the inner support part is against the inner wall of the bottom case and faces the hollow part, so that the other end of the elastic plate leans toward the two limiting parts,
a through hole is provided in a center of the front cover, and the pressure plate is assembled inside of the front cover, the front cover is assembled on a front side of the bottom case,
the pressure plate faces the elastic plate, and the pressure plate is provided with two inner push plates to support the elastic plate, the pressure plate can be pressed through the through hole, so that the elastic plate has an action state of pressing to unlock and rebounding the lock.

3. The safety belt structure of claim 2, wherein the quick-release buckle clip comprises a clip hole, the clip hole is snap-fitted with the protruding part, and further inserts and fixes the quick-release buckle clip on the elastic buckle locks.
